(19) United States
(12) Patent Application Publication
(10) Pub. No.: US 2013/0233059 A1
(43) Pub. Date: Sep. 12, 2013

(54) RHEOMETRY INSTRUMENT UTILIZING SURFACE ACOUSTIC WAVES

(71) Applicants: Amarin McDonnell, Victoria (AU); Pradipto Bhattacharjee, Victoria (AU); James Friend, Victoria (AU); Leslie Yeo, Victoria (AU); Prabhakar Ranganathan, Victoria (AU)

(72) Inventors: Amarin McDonnell, Victoria (AU); Pradipto Bhattacharjee, Victoria (AU); James Friend, Victoria (AU); Leslie Yeo, Victoria (AU); Prabhakar Ranganathan, Victoria (AU)

(73) Assignee: Royal Melbourne Institute of Technology, Victoria (AU)

(21) Appl. No.: 13/805,711

(22) PCT Filed: Jun. 22, 2011
(86) PCT No.: PCT/AU2011/000749

§ 371 Date: Feb. 28, 2013

(30) Foreign Application Priority Data
Jun. 22, 2010 (AU) 2010902707

(51) Int. Cl. G01N 11/02

(52) U.S. Cl. CPC G01N 11/02
USPC 73/54.04

(57) ABSTRACT

A capillary break-up extensional rheometry (Ca BER) instrument including: opposing plates between which a capillary fluid bridge can be formed; and a surface acoustic wave (SAW) actuator having a working surface located on one of the plates, wherein when the test fluid is applied to the working surface of the SAW actuator, and the SAW actuator is energised, a said liquid bridge of the test fluid is produced between the plates.

### FIELD OF THE INVENTION

The present invention is generally directed to a capillary break-up extensional rheometry (CaBER) instrument and method of use thereof, and is in particular directed to a CaBER instrument utilizing surface acoustic waves (SAW).

### BACKGROUND TO THE INVENTION

The non-Newtonian effects encountered in the flow of complex fluids, having a low zero-shear-rate viscosity (η₀) and a small relaxation time (λ), through microscopic channels and vessels are of general interest in a number of areas of physics, biology and technology. As the length scale of flow (l) decreases the non-Newtonian effects of the fluid can be significantly magnified since the Deborah number De=λV/l and the elasticity number EI=η₀λ/ρl both approach values greater than unity. Here “V” is the characteristic velocity of flow and “ρ” the density of the fluid. While development of microfluidic instruments have significantly enhanced our understanding of the non-Newtonian behaviour of this class of fluids in shearing flows, characterization of the response in extensional flows has been difficult since the inertial contributions mask the non-Newtonian effects. The technique of capillary break-up extensional rheometry, that uses the necking/thinning of a liquid bridge of a fluid under the influence of surface tension for measuring visco-elastic properties, is promising in this regard because as the liquid bridge necks/thins down the dynamics of the fluid occurring over a wide span of length scales can be studied. At small length scales, the influence of inertia decreases with the Reynolds number Re=ρVel/η₀ and the non-Newtonian effects become more conspicuous as mentioned above even for small values of η₀ and V. An additional advantage is that the geometry of the liquid bridge constrains the location of the minimum neck radius to the mid-plane of the fluid thread. This makes following the necking processes easier compared to other analogous techniques like jet break up and drop pinch off where the position of the neck varies in time and space.

In current CaBER instruments, a liquid bridge is created by rapidly separating two endplates within which a small volume of the test fluid is held, in a finite time δt₀. If δt₀ exceeds the viscous time, τᵥ=14.1η₀R/γ where R is the radius of the droplet and γ is the surface tension of the fluid respectively, liquid thread can disintegrate into droplets even before the separation of the plates is completed. The balance, τᵥ=δt₀, implies that the lowest viscosity (η_{0,min}) necessary for bridge formation is given by η_{0,min}=δt₀γ/14.1R. For a prototypical Newtonian fluid used in current CaBER instruments, γ=60×10⁻³N/m, and R=3 mm. Also using current technology the smallest value of δt₀ is of order 50 ms, which implies that η_{0,min}=70 mPa. The above condition serves as a stringent lower bound, or “cut-off” on Newtonian viscosity that can be used in current CaBER instruments. Additionally, inertio-capillary oscillations of the bridge that result from the abrupt halting of the endplates can disrupt the liquid bridge immediately after its formation if the viscosity is not large enough. Therefore, these problems impede the extension of the CaBER technique to encompass low viscosity fluids because liquid bridges of Newtonian fluids with viscosities below 70 mPa are difficult if not impossible to generate using current instrumentation.

It is therefore an object of the present invention to provide a CaBER instrument that can be used for low viscosity fluids, and preferably, fluids having a viscosity of less than 70 mPa.

It is another preferred object of the present invention to provide a CaBER instrument that requires substantially lower amounts of fluid than current CaBER instruments to operate correctly.

### SUMMARY OF THE INVENTION

According to one aspect of the present invention, there is provided a capillary break-up extensional rheometry (CaBER) instrument including:

opposing plates between which a capillary fluid bridge can be formed; and

a surface acoustic wave (SAW) actuator having a working surface located on one of the plates,

wherein when the test fluid is applied to the working surface of the SAW actuator, and the SAW actuator is energised, a said liquid bridge of the test fluid is produced between the plates.

The SAW actuator may be located on either of said opposing plates. Generally, the plates may be located in a top or bottom position relative to each other. Therefore, if the SAW actuator is located on the bottom positioned plate, the liquid bridge may be produced from an upwardly extending fluid jet. Alternatively, if the SAW actuator is located on the top positioned plate the liquid bridge may be produced from a downwardly extending fluid jet.

In earlier studies with SAW actuator, the phenomenon of SAW driven fluid jetting has been observed. Surface acoustic waves (SAW) are electro-elastic waves that move along the surface of the SAW actuator when actuated. The energy of these waves can be focussed into a fluid droplet placed on the working surface the SAW actuator resulting in acoustic streaming within the droplet. At sufficiently large intensities, an elongate column or “jet” extending away from the actuator working surface can be produced.

With sufficient energisation of the SAW actuator, the fluid jet can reach and briefly adhere to an opposing surface to form the liquid bridge. This interfacial jetting phenomenon is utilised in the present invention.

According to a preferred arrangement according to the present invention, the CaBER instrument may further include a second surface acoustic wave (SAW) actuator. This second SAW actuator may be located on the other of the plates, and may be located opposite to the SAW actuator on the opposing plate. Fluid jets may then be produced at the same time from each of the SAW actuators, the opposing fluid jets joining to thereby form the liquid bridge.

The opposing plates of the CaBER instrument may preferably be located a fixed distance apart. According to the experiments conducted and subsequently described in the present application, this distance was set at 10 mm. It is however also envisaged that the plate separation may be set anywhere within the range of between 0 to 50 mm.

The SAW actuator must be energised at an intensity sufficient to produce the required interfacial jetting between the opposing working surfaces. Therefore, according to the present invention, energisation of the SAW actuator resulting in a vibration velocity amplitude of 1 to 10 nm is envisaged. Preferably, the vibration velocity amplitude may be about 5 nm.

Unlike current CaBER instruments which require a relatively large amount of fluid to produce the liquid bridge, the present invention only requires a relatively small amount of test fluid to be applied to the SAW actuator. Typically, only a single pipette drop is required for the test procedure. This is particularly advantageous where only a small amount of test fluid is available, or where the cost of obtaining the test fluid is high.

As the liquid bridge is created using SAW driven fluid jetting, and not by the rapid separation of two plates, the CaBER instrument according to the present invention is not constrained by the same operational limitations as current instruments, and can be used for the measurement of fluids of low viscosity (in particular, less than 70 mPa). Current CaBER instruments are unable to measure fluids of this low viscosity. This extends the application of CaBER to the measurement of relatively low viscosity fluids used for example as pesticides, or in protein crystallography. The present invention may also be used to measure the properties of naturally occurring fluids such as milk.

With this in mind, according to another aspect of the present invention, there is provided a method of measuring the extensional flow behaviour of a viscous fluid using a CaBER instrument as described above. These may include low viscosity and naturally occurring fluids as noted above.

The CaBER instrument according to the present invention also has applications in the study of the mechanical properties of living matter, and in particular, of suspensions of motile/microbes. In such suspensions, it has been found that it is the hydrodynamic interaction between particles that leads to coherent flows within the bulk. Suspensions of cells, or the cytoplasm within single cells, consist of self-propelled particles that also interact with each other, and thus produce stresses that result in dynamic self-organization at spatial and temporal scales much larger than those of single particles. This view of collective motion is now beginning to explain the way for instance, cytoskeletal filaments achieve motion observed in white blood cells, or cancer cells. A further example is bacterial “turbulence” in which motile bacteria within an outwardly still suspension are within such proximity that the fluid flow caused by a swimming cell interacts with the orientation of neighbouring cells causing hydrodynamic instabilities that bear superficial resemblance to flow structures in high Reynolds-number turbulence.

Such suspensions of self-propelled particles are now referred to as being “active”. Active materials in general possess several defining features. Firstly, energy enters the system via the individual particles themselves without any need for any external forcing. Secondly, in the kinds of biological systems we are interested the net force exerted by each suspended particle on the surrounding fluid is zero. The Reynolds numbers corresponding to the motion of these micro- or nano-particles are negligible. Thus, particles propel themselves in the near absence of inertia. Under such conditions, the frictional drag force on a particle is exactly balanced by the hydrodynamic propulsion. The equal and opposite forces exerted by the particle on the fluid also therefore sum to zero. However, the centres of action of each of these two forces are not the same, and to reduce the complexities of these systems, current theoretical approaches idealise particles as small hydrodynamic dipoles. The instantaneous orientation of each particle defines both the directions of the hydrodynamic dipole, and its motion. These hydrodynamic dipoles set off flows in the ambient fluid which then perturbs the orientation and motion of surrounding particle dipoles. Dipoles are further classified as being “contractile” and “extensile”. In the context of rod-like particles, contractile particles draw fluid inwardly along their principle axis and expel it perpendicular to their principle axis; conversely, extensile particles will draw fluid inwardly perpendicular to their principle axis and expel it along their principle axis. Such particles are also referred to as “pullers” and “pushers”, respectively.

The theory of active matter hydrodynamics predicts that pullers and pushers in a suspension modify its viscosity, relative to its value for a passive suspension consisting of non-self-propelled particles of the same size and shape. Subjecting an active fluid suspension to a shear flow results in the alignment of the principle axis of the particles with the direction of the flow. Given this alignment, a suspension of pullers will contract flow against the principal stretching direction of the shear, increasing the stress/strain rate ratio, and thus increasing the viscosity. On the other hand when pushers are aligned with this flow they will push in the direction of the imposed flow, enhancing it, and thus reducing viscosity. The same effect, due to puller and pusher particles, is also predicted on viscosity in extensional flows.

This theory can be tested using the CaBER instrument according to the present invention which allows the extensional flow behaviour in fluids of low viscosities such as is the case with active suspensions.

### BRIEF DESCRIPTION OF THE DRAWINGS

The present invention will now be described with reference to the following Figures which illustrate experiments conducted using a CaBER instrument according to the present invention. In is to be appreciated that the present invention is not limited to the experimental example and that other embodiments are also envisaged as detailed in the preceding description of the invention.

In the drawings:

FIG. 1 (a) to (c) respectively show in (a) CaBER instrument according to the present invention; in (b) an operating diagram denoting the test fluids used, and in (c) millisecond time lapse photos showing the formation of a coherent jet which forms into a liquid bridge necks down under the influence of capillary forces acting act the interface (in the experiment, the SAW actuator is located at the top plate so that the formation of the fluid jet is assisted by gravity);

FIG. 2 (a) to (d) respectively show plots of in (a), the normalised radius of MX1(□) and DOP (▪) plotted against time after creation of the liquid bridge showing a linear decay of the radius with time; (b) the same data plotted to emphasise the viscocapillary balance; (c) the same data of plotted with the abscissa normalised by the break up tine; and (d) the capillary thinning behaviour of polymeric fluids PS1 (Δ) compared to a DOP (▪);

FIG. 3 is a plot showing voltage against time taken to create a liquid bridge of dioctyl phthalate with a plate distance set at 10 mm; and

FIG. 4 is a Table showing the various fluid properties of the test fluids; and

FIG. 5 shows at the top panel: Evolution of the filament diameter (in pixels) against time (seconds) of suspensions of live (∘) and dead (•) cells. Left: D. tertiolecta sample at an OD of 65.86. Right: E. coli sample at an OD of 200, and at the bottom panel: Concentration dependence of filament break-up times t_{bu} for live (white symbols) and dead (black symbols) cell suspensions for D. tertiolecta (left) and E. coli (right). The encircled data points indicate high concentrations at which the effect of cell motility is small.

### DETAILED DESCRIPTION OF THE INVENTION

A surface acoustic wave is a pressure wave that travels along the surface of a material, with an amplitude that typically decreases exponentially with the depth in the medium. Liquid jets from sessile droplets can be generated using SAW by focusing the energy of the electro-elastic waves (typically of 1-10 nm in amplitude) propagating along the substrate surface to a spot of size equivalent to the wavelength of radiation such that a part (determined by the relative acoustic impedance) of the concentrated energy “leaks” into a droplet placed at the focal point. At sufficiently large intensities, acoustic streaming results and an elongated column of the fluid, a few centimetres in length are formed.

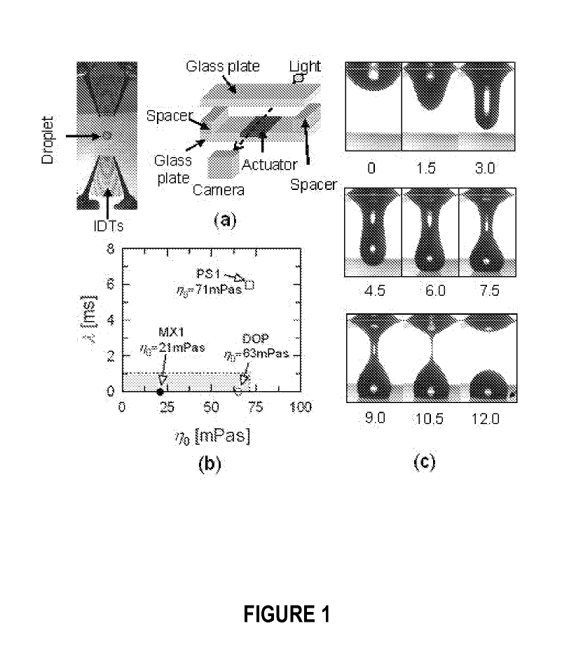

The SAW device used in these experiments has a resonance frequency of 30 MHz. In the experiments, the SAW was generated by supplying a sinusoidal voltage to an interdigital transducer (IDT) fabricated on a 0.5 mm thick lithium niobate (LN) piezoelectric crystal. The section between the IDTs was coated with a thin layer of Teflon in order to provide a hydrophobic surface. Single drops were placed with a pipette at the focal point of the IDTs before subjecting the fluid to a SAW burst. A photograph of the configuration with the quiescent droplet is shown in FIG. 1(a). A 20 MHz Waveform Generator was used to determine the burst time. The output from the waveform generator was also used to trigger another signal generator. The latter determined the signal amplitude and maintained the frequency of the output signal close to resonant frequency of the device. The resulting signal was communicated to the device via an FR power amplifier.

In order to obtain a liquid bridge a glass plate was placed directly opposing the plate containing the SAW device as shown in FIG. 1(a). Following the excitation of the droplet by SAW the liquid filament that was produced bridged the separation between the two plates to form the liquid bridge. The SAW burst was stopped when the near equal distribution of the material between the plates was obtained. Using this technique liquid bridges have been created in 7.5 ms, which is about 7 times quicker than the existing technology. The capillary thinning behaviour of fluids with viscosity as low as 21 mPas, less than half of ζ_{0,min}, has also been observed.

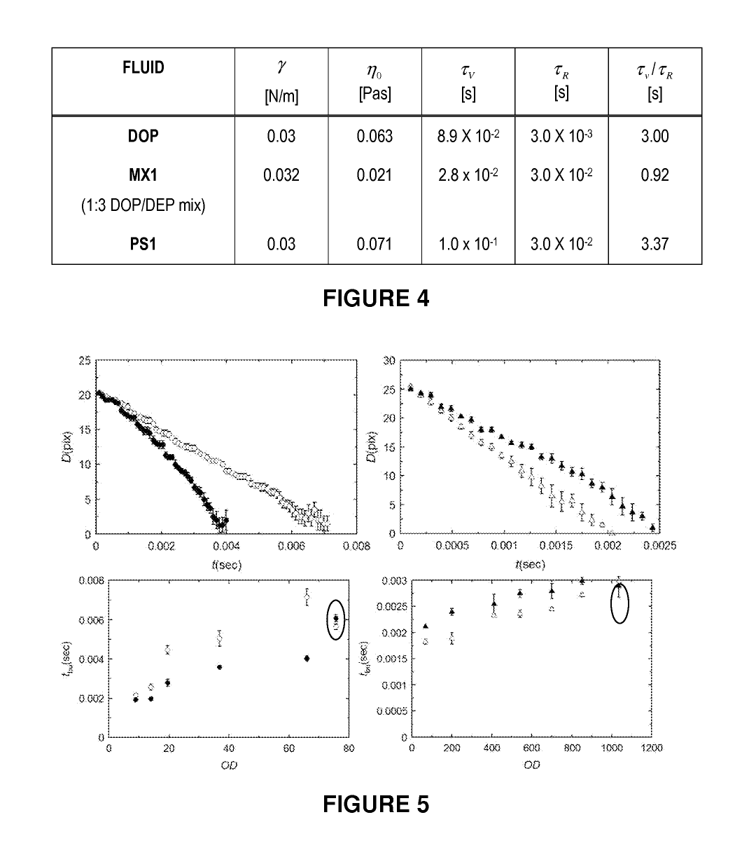

The details of the fluids used are provided in Table 1 (see FIG. 4), where the viscous time, τᵥ=14.1η₀R/γ, and the Rayleigh time, τ_{R}=\sqrt{ρR³/γ} are provided. The time-scales are calculated based on R=3 mm, which is a typical radius used in a CaBER experiment, to facilitate comparison. Strictly speaking only fluids having τᵥ<τ_{R} can be considered as low viscosity fluids. In that sense MX1, which is a mixture of 2 parts of diethyl phthalate (DEP) and 1 part of dioctyl phthalate (DOP) is the only low viscosity fluid for a traditional CaBER experiment. However, due to the restrictions imposed by the opening time (δt₀) liquid bridges of fluids of similar order in viscosities are difficult to obtain for reasons mentioned above. The present experiments are, thus, significant in this context. A prototypical operating diagram for CaBER is shown in FIG. 1(b), where the shaded regions denote the area where CaBER experiments are rendered impractical due to the limitations of current technology. In the diagram, the boundaries of the present case are marked by straight lines, instead of a curve, for simplicity. These limits can be altered marginally by a sensible choice of the geometry and operating conditions, but the differences are not significant. The points on the diagram in FIG. 1(b) denotes the fluids used in this work.

Once formed, the liquid bridge necks down under the influence of surface tension. Images of the necking process were captured using a high speed camera. A single-LED lamp was used, as back-light, to illuminate the events and a 1.25 mm wire was used as a visual reference during recording. The image sequences collected at 5000 frames per second and were analysed. The break-up event could be ascertained within ±0.5 ms using current imaging and illumination capabilities. An example of the bridge-formation and necking behaviour is demonstrated in FIG. 1(c). It can be observed from FIG. 1(c) that the liquid bridge is formed at around 7.5 ms and the break-up event is encountered around 12 ms.

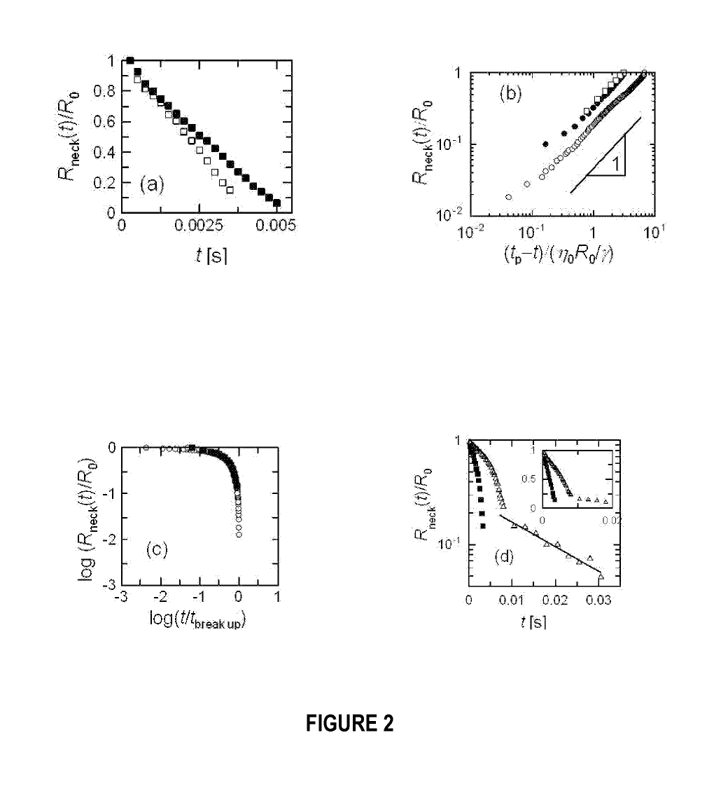

In FIG. 2(a) the capillary thinning behaviour of two liquids DOP and MX1 are shown. The ratio of the minimum (instantaneous) radius (R_{neck}(t)) normalized by the initial radius of the liquid bridge (R₀) is plotted against time (t). On all occasions the minimum in the radius was observed to occur near the mid-point of the liquid bridge. The neck diameter decreases linearly with time until the break-up event is encountered. Also, the break-up of the fluid with the lower viscosity occurs earlier. For viscous fluid threads undergoing surface tension driven necking, R_{neck}(t)˜(t_{ρ}−t)(γ/η₀), where t_{ρ} is the time at which the break-up event occurs, γ is the surface tension coefficient, η₀ is the zero shear rate viscosity of the fluid. The linear decrease in R_{neck}(t) is well represented in our experiments. In FIG. 2(b) the data in FIG. 2(a) is plotted so as to further demonstrate the validity of the above correlation in our experiments. In this plot we have also included data on glycerol having viscosity of 1 Pas for comparison. In FIG. 2(c) we present the same data on logarithmic scales are normalizing the abscissa by the observed break-up time. The approach to break up agrees remarkably well with previously documented behaviour.

The change in the capillary thinning behaviour due to the addition of a small quantity of long chain polymer molecules is shown in FIG. 2(d). Here the response of a PS1, a 0.04% by weight solution of high molecular weight polystyrene (M_{w}=7.0×10⁶ g/mol) in DOP is compared with that of pure DOP. As is evident, both the solutions follow a linear decrease in neck radius initially (inset), although the rate of decrease is lower for PS1 on account of higher viscosity that results from the dissolution of the polymer. However, unlike DOP which eventually undergoes break-up, the break up process is arrested in PS1 and the dynamics transition abruptly to a regime where the R_{neck}(t) decreases exponentially with time. In a capillary thinning experiment involving a polymer solution the elastic stresses can grow large enough to overwhelm the viscous stresses in the neck. In fact when the elasto-capillary stress balance dominates the filament radius decays as R_{neck}(t)/R₀˜exp(−t/3λ), where λ is the relaxation time of the fluid. The relaxation time for PS1 estimated by fitting an exponential function to the data yields a value of around 6.1 ms, which is of the order of the smallest value of relaxation time that can be measured using conventional CaBER instrumentation.

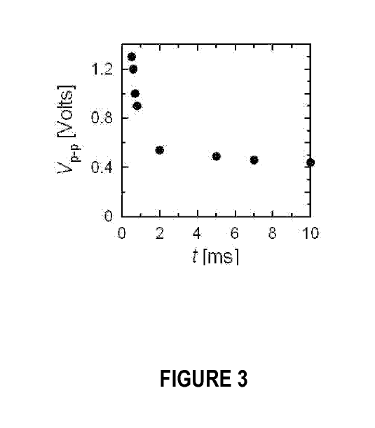

An advantage of using SAW is that δt₀, the time taken to create the liquid bridge using a given fluid can be made smaller by adjusting the voltage driving the IDTs. In FIG. 3 the decrease in the time required to make a liquid bridge of DOP across two glass plates separated by 10 mm, with increasing voltage is shown. An additional advantage is that the volume of test fluid required is about one micro-litre which is three orders of magnitude smaller than the volume required in current techniques. These aspects make the technology attractive for constructing extensional rheometers that are capable of characterizing weakly elastic fluids with low viscosity.

The CaBER instrument can be used to measure the extensional viscosities of active suspensions of motile microbes. In the tests, suspensions of two microorganisms were chosen. The first was the green alga Dunaliella tertiolecta which swims using two flagellae. The second chosen was Escherichia coli, and a multiple flagellated bacterium that performs run and tumble swimming.

### Culturing Protocols and Test Sample Preparation

A wild type Escherichia coli K 12 (#10798, ATCC USA) strain was procured. Throughout the study, a standard media for bacterial growth in the form of LB Broth (#L3022, Sigma Aldrich) and/or Luria Agar (#L2897, Sigma Aldrich) was used. A UV-VIS spectrophotometer (#UV-2450, Shimadzu) was used to characterize the bacterial growth by measuring absorbance/optical density at 600 nm.

About 0.5 ml of sterile LB broth (autoclaved at 121° C. for 15 minutes at 15 psi) was put into a sterile ATCC vial containing the lyophilized culture (in powdered form) in a sterile environment (inside a laminar air-hood) after carefully removing the seal. The powdered culture was thoroughly thawed by suspending it in the liquid medium and pippeting it for 5-10 times. A small amount of the suspended culture (around 0.05 ml) was taken and put into pre-prepared sterile Luria agar slants. Isolated pure colonies of Escherichia coli K 12 strain were obtained by incubating the slants at 37° C. for 18-20 hours. Under sterile conditions, a single colony was transferred to 5 ml of sterile LB broth and incubated at 37° C. for 6-7 hours with vigorous shaking (at 170 rpm), till the absorbance at 600 nm reaches 0.4. About 0.3 ml of 50% glycerol was added to 0.7 ml of this log-growth phase culture and stored at −73° C. for future use.

From the glycerol freeze stock, a small amount was scraped off and inoculated under aseptic conditions to 5 ml of sterile LB medium. The culture was incubated at 37° C. for 16-18 hours with vigorous shaking (at 170 rpm). Under sterile conditions, a small amount of the overnight culture (around 0.05 ml) was transferred into pre-prepared sterile LB media of appropriate volume (40 ml/80 ml/120 ml/160 ml etc.). The cultures were incubated at 37° C. for 6-7 hours with vigorous shaking (at 170 rpm), till the absorbance at 600 nm reaches 0.4. The entire culture volume was evenly distributed into 50 ml polypropylene capped-tubes and centrifuged at 4550 rpm at 4° C. for 10 minutes to collect the cell pellet. The cell pellet was weighed (for the wet cell mass) prior to resuspending in a buffer containing 10 mM K₂HPO₄, 0.1 mM EDTA and 0.2 wt. % glucose (pH 8.2). The cell density was characterized by measuring the absorbance of the dissolved pellet (in the buffer) at 600 nm. Special care was taken and appropriate dilution was made to ensure the absorbance readings fall within the linear range (0.1 to 0.5).

After resuspending cells in buffer, samples for SAW-actuated-CaBER testing were maintained at 37° C. The live cell samples were subjected to UV light exposure to prepare suspensions of dead cells at the same volume fraction. Microscopic examination confirmed that cells did not lyse after exposure to UV radiation.

Dunaliella tertiolecta Butcher was collected and isolated from Port Phillip Bay, Victoria, in December 2009. Cultures were maintained in a modified ‘f-medium’. The medium consisted of 30 g/L aquarium salt, 250 mg/L NaNO₃, 18.0 mg/L KH₂PO₄, 9.0 mg/L iron(III) citrate C₆H₅O₇Fe, 9.0 mg/L citric acid, 0.200 mg/L MnCl₂.4H₂O, 0.023 mg/L ZnSO₄.7H₂O, 0.011 mg/L CoCl₂.6H₂O, 0.005 mg/L CuSO₄.5H₂O, 0.008 mg/L Na₂MoO₄.2H₂O, 0.00065 mg/L H₂SeO₃ and traces of vitamin B12, biotin and thiamine. Cultures were grown in a laboratory growth cabinet (Labec, Laboratory Equipment P/L, Australia) maintained at 20° C.±0.1²C with a 16:8 light dark cycle using white fluorescent lights with a photon flux of −60 μmol photon m⁻² s⁻¹. Cultures were bubbled with air through an aquarium air stone to provide a source of inorganic carbon (CO₂). They were grown in 2 L glass bottles (Pyrex®, Laboratory Glassware, Australia). Samples used in experiments were harvested during the log phase of growth into 50 ml polypropylene capped-tubes and centrifuged at 3500 rpm at 20° C. for 10 minutes to collect the cell pellet, which was then resuspended in the modified f-medium to prepare samples for CaBER testing. Optical density measurements were taken at 750 nm. To prepare samples of dead cells, a few drops of Lugol's solution (10 g/100 mL KI solution with 5 g/100 mL of iodine crystals) is added to kill cells. Lugol's solution is a gentle preservative that kills microalgae while maintaining cellular integrity.

### Results

In the top panel of FIG. 5 we show typical evolutions of mid-filament diameters with time. It is observed that for D. tertiolecta (FIG. 5 left), necking of the filament of a live cell suspension (white symbols) is slower than that of dead cells (black symbols) at the same cell density. This behaviour is however reversed for the E. coli samples (FIG. 5 right). It is known that the rate of filament necking decreases with increasing fluid extensional viscosity. These differences between live and dead cell suspensions are consistent across a range of cell densities, as shown in the bottom panel of FIG. 5 filaments of live D. tertiolecta suspensions take longer to break up, whereas E. coli suspensions break up faster, than the corresponding dead cell suspensions. Hence, in the case of D. tertiolecta, active suspensions have a higher extensional viscosity than suspensions of passive particles of identical size and volume fraction, indicating that D. tertiolecta may be classified as pullers. On the other hand, the viscosity reduction caused by swimming E. coli makes those cells pushers.

However, for both organisms, the break-up time data t_{bu} in FIG. 5 shows that at high enough concentrations, the difference between live and dead cell suspensions disappears. Microscopic examination does show that at these high densities, cells are closer together. However, further measurements are necessary to determine whether motility is completely suppressed in the live cell suspensions at those concentrations. Collective motion has been observed in other studies fairly dense bacterial colonies.

Modifications and variations as would be deemed obvious to the person skilled in the art are included within the ambit of the present invention as claimed in the appended claims.

1. A capillary break-up extensional rheometry (CaBER) instrument including:
opposing plates between which a capillary fluid bridge can be formed; and
a surface acoustic wave (SAW) actuator having a working surface located on one of the plates,
wherein when the test fluid is applied to the working surface of the SAW actuator, and the SAW actuator is energised, a said liquid bridge of the test fluid is produced between the plates.

2. A CaBER instrument according to claim 1, further including a second surface acoustic wave (SAW) actuator located on the other of the plates, and opposite the first SAW actuator.

3. A CaBER instrument according to claim 1, wherein the opposing plates are fixed at a set distance apart.

4. A CaBER instrument according to claim 3, wherein the opposing plates are fixed 10 mm apart.

5. A CaBER instrument according to claim 1, wherein the distance between the opposing plates is variable within the range of 0 to 50 mm.

6. A CaBER instrument according to claim 1, wherein the SAW actuator(s) is energised to provide a surface acoustic wave having a vibration velocity amplitude of between 1 to 10 nm.

7. A CaBER instrument according to claim 5, wherein the SAW actuator(s) is energised to provide a surface acoustic wave having a vibration velocity amplitude of 5 nm.

8. A method of measuring the extensional flow behaviour of a viscous fluid using a CaBER instrument including opposing plates between which a capillary fluid bridge can be formed, and a surface acoustic wave (SAW) actuator having a working surface located on one of the plates, comprising:
applying a test fluid to the working surface of the SAW actuator; and
energizing the SAW actuator to produce a liquid bridge of the test fluid between the plates.

9. A method as claimed in claim 8 wherein the viscous liquid has a viscosity less than 70 mPa.

10. A method as claimed in claim 8, wherein the viscous liquid is a suspension of motile microbes.
